(19) United States
(12) Patent Application Publication
(10) Pub. No.: US 2015/0108682 A1
(43) Pub. Date: Apr. 23, 2015

(54) METHOD OF MAKING A FILTER SEAL

(71) Applicant: Lincoln Global, Inc., City of Industry, CA (US)

(72) Inventor: Theresa M. Spear, Highland Heights, OH (US)

(73) Assignee: LINCOLN GLOBAL, INC., City of Industry, CA (US)

(21) Appl. No.: 14/191,657

(22) Filed: Feb. 27, 2014

Related U.S. Application Data
(60) Provisional application No. 61/894,613, filed on Oct. 23, 2013.

(51) Int. Cl. B01D 27/08; B29C 45/14

(52) U.S. Cl. CPC B01D 27/08; B29C 45/14467; B29C 45/14336
USPC 264/248; 264/263

(57) ABSTRACT

The invention relates to an injection molding process to make a sealing surface about a periphery of a filter cartridge.

### CROSS-REFERENCE TO RELATED APPLICATIONS

This application claims priority to and fully incorporates by reference, pending U.S. patent application Ser. No. 61/894,613 filed on 23 Oct. 2013.

### TECHNICAL FIELD

The invention described herein pertains generally to a method of making a filter seal using an injection molding process.

### BACKGROUND OF THE INVENTION

Welders are in constant contact with airborne particles which can be harmful to their health. Welders either breath the harmful fumes directly or wear uncomfortable respirators with a High Efficiency Particulate Air (“HEPA”) filter. When using a respirator, the welder is still constantly in physical contact with the welding fumes, especially airborne manganese, and other airborne debris.

Respirators can become irritating for a welder since airborne debris becomes accumulated around the seal portion of the respirator. Also, because of the intense heat associated with welding, the welder is likely to perspire while wearing a respirator.

One option for the welder is to use a waist belt having supporting respiratory components. Fan-forced positive pressure breathing devices, commonly referred to as powered air purifying respirators (PAPRs) and other respiratory components are used by first responders, military, and other emergency response units to manage respiratory exposure. These and other respiratory components are also used in various industrial applications to manage exposure to gases, vapors, and particular matter. A respiratory system may include a breathing mask, or other suitable hood, helmet, or hardtop, having an inlet for filtered air and defining a zone of breathable air for the user. Such systems are employed to continually supply positive pressure to the breathable air zone. The respiratory system components generally are securely connected to the belt, or may be positioned on the breathing mask, or other suitable helmet, or hardtop.

At least one component of the respiratory system is a filter, typically a HEPA filter. The filter must satisfy certain standards of efficiency such as those set by the United States Department of Energy (“DOE”). To qualify as HEPA by US government standards, an air filter must remove (from the air that passes through) 99.97% of particles that have a size of 0.3 micrometers (American Society of Mechanical Engineers, ASME AG-1a-2004, “Addenda to ASME AG-1-2003 Code on Nuclear Air and Gas Treatment”, 2004).

As typically used in a welding helmet application, HEPA filters are typically composed of a pleated mat of randomly arranged fibers. In manufacture, pleated or non-pleated HEPA (and other filters) are inserted into a molded plastic compartment (which may or may not be curvilinear in its longitudinal dimension). The interior side of the filter typically has a foam sealing surface affixed to the interiorly facing periphery of the compartment. This foam sealing surface is typically die-cut from a sheet of foam and adhesively secured to the interior peripheral face of the compartment. This type of manufacture leads to significant waste of the foam sheet, as well as labor in adhesively securing the foam to the compartment.

Therefore, it is easily seen that what is needed is a more facile process of securing the sealing surface to the interior peripheral face of the compartment into which the HEPA filter is secured.

### SUMMARY OF THE INVENTION

In accordance with the present invention, there is provided a process for making a filter cartridge comprising the steps of: inserting a filter into a polymeric filter cartridge, the cartridge having an apertured bottom and a pair of opposed raised sides; inserting a cartridge into the bottom apertured filter cartridge; affixing a polymeric apertured retaining top onto a top of said filter cartridge to form a filter assembly; positioning the filter assembly into a split mold having a cavity dimensioned to accommodate the filter assembly, one side of said split mold having a cavity about a periphery of the filter assembly; injection molding a sealing polymer about the periphery of the filter assembly, the sealing polymer and the polymeric filter cartridge or the polymeric retaining top forming either a chemical or physical bond therebetween; and opening the split mold and removing the filter assembly having a sealing polymer about the periphery of the filter assembly.

In one aspect of the invention, the sealing polymer and the polymeric filter cartridge or the polymeric retaining top are at least partially miscible. In another aspect of the invention, at least a portion of the sealing polymer composition and at least a portion of the polymeric filter cartridge or at least a portion of the polymeric retaining top are compatible.

In an aspect of the invention, the sealing polymer composition and the polymeric filter cartridge or the polymeric retaining top are at least partially miscible.

In another aspect of the invention, the retaining top fits into a lip of a top surface of the pair of opposed raised sides of the polymeric filter cartridge. The sealing polymer is optionally colored and the polymeric filter cartridge and the polymeric retaining top are typically curvilinear along a longitudinal axis.

The sealing polymer typically has a range of from approximately 30 Shore A to 75 Shore D and preferably the composition of the polymeric filter cartridge and the polymeric retaining top are of a plastic which is harder than the sealing polymer using a Shore scale.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawing which form a part hereof, and wherein:

FIG. 1 is a perspective view of an assembled filter cartridge including injection molded seal; and

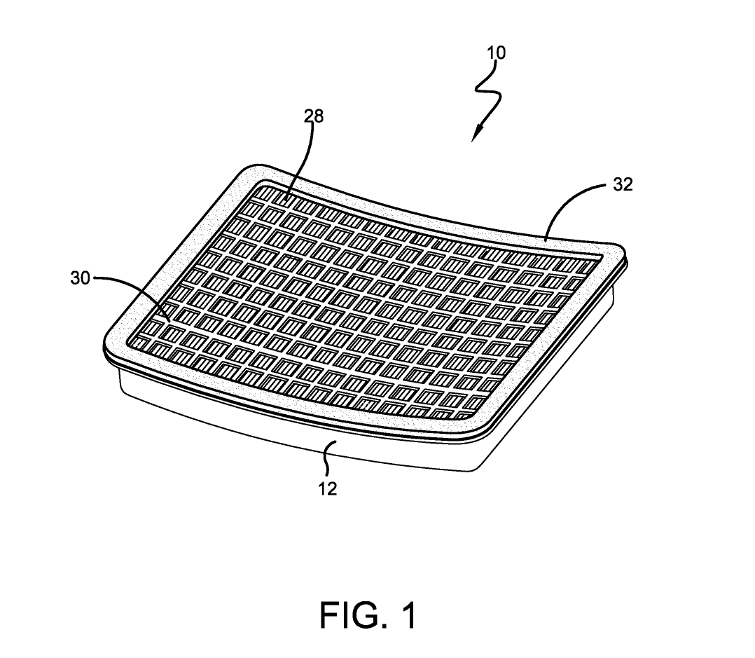

FIG. 2 is an assembly view of FIG. 1 without the injection molded seal.

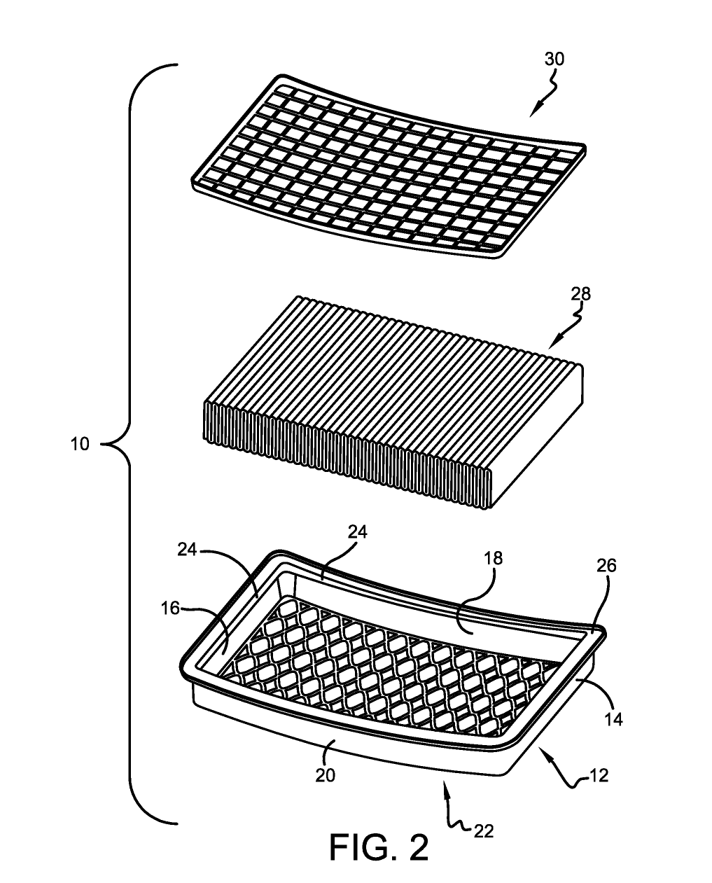

### DETAILED DESCRIPTION OF THE INVENTION

The best mode for carrying out the invention will now be described for the purposes of illustrating the best mode known to the applicant at the time of the filing of this patent application. The examples and figures are illustrative only and not meant to limit the invention, which is measured by the scope and spirit of the claims.

The invention relates to a molding process in the manufacture of a filter component cartridge 10 in which a split die is typically used in combination with an injection molding process. This die will have an internal cavity which is adapted mold compartment 12 having two opposed pairs of sidewalls 14,16 & 18,20 and a exteriorly-facing apertured bottom grid 22 having openings disposed therein, into which filter 28 (pleated or non-pleated) is inserted therein. An interiorly-facing apertured retaining top grid 30 having openings disposed therein, is inserted and securedly fastened into lip 24 about an internal peripheral edge of each opposed pair of sidewalls 14,16 & 18,20. While insertion into a lip is preferred, it is not required, and top grid 30 may be affixed to laterally-extending top ledge 26 on each opposed pair of sidewalls. The assembled filter/compartment combination is then positioned into a die having an internal cavity which is dimensioned to mold sealing surface 32 onto laterally-extending ledge 26 of either the two opposed pairs of sidewalls or a laterally-extending ledge of the top grid by injection molding of a sealing polymer, copolymer or terpolymer or combinations thereof.

Injection molding of thermoplastics is a process by which plastic is melted and injected into a mold cavity void, defined in this instance as the void volume between the inserted molded compartment and the mold cavity. Once the melted plastic is in the mold, it cools to a shape that reflects the form of the cavity and core. The resulting part is a finished part needing no other work before assembly into or use as a finished part. The injection molding machine has at least one and sometimes, two basic components: an injection unit to melt and transfer the plastic into the mold, and optionally, a clamp to hold the mold shut against injection pressures and for part(s) removal. The injection unit melts the plastic before it is injected into the mold, then injects the melt with controlled pressure and rate into the mold.

Important factors in the processing of plastic include temperature, consistency, color dispersion and density of the melt. Conductive heat supplied by barrel temperature and mechanical heat generated by screw rotation both contribute to the processing of good quality melt. Often, most of the energy available for melting the plastic is supplied by screw rotation. Mixing happens between screw flights and the screw rotates, smearing the melted surface from the plastic pellet. This mixing/shearing action is repeated as the material moves along the screw until the plastic is completely melted.

If the polymer is a thermoset, injection molding uses a screw or a plunger to feed the polymer through a heated barrel to decrease its viscosity, followed by injection into a heated mold. Once the material fills the mold, it is held under pressure while chemical crosslinking optionally occurs to make the polymer hard. The cured part is then ejected from the mold while at the elevated temperature and cannot be reformed or remelted.

When thermoplastics are heated in an injection press, they soften and as pressure is applied, flow from the nozzle of the press into an injection mold. The mold has cavities that, when filled with the thermoplastic material, define the molded part. The material enters these cavities through passages cut into the mold, called runners. The mold also has passages in it to circulate a coolant, usually water, through strategic areas to chill the hot plastic. As it cools, the thermoplastic material hardens. When cooled enough, the mold opens and the part is removed.

While the precise composition of the plastic compartments (both interior and exterior) and sealing polymer are not required to be of any specified composition, in general, there are several guidelines which are applicable in the practice of this invention. It is of course, recognized that the precise operating conditions utilized in the injection molding process are well-known in the art and are specific to each injection molded polymer. It is well within the skill of the art to determine the applicable conditions which will result in the appropriate injection molded sealant polymer and plastic compartments. The degree of flexibility of the plastic compartments is not of particular relevant for this invention. The plastic compartments can be a thermoplastic or a thermoset. At least one key is that the injection molded polymeric seal must be capable of forming a bond, either chemical or physical, with the plastic of the compartments.

In the practice of this invention, illustrative and non-limiting examples of the polymers which are believed to be useful in various combinations to form the plastic compartments as well as polymers which may be used in the injection molding process to form seals of the cartridges with various adjacent component parts would include many of the polymers known-in-the-art, including at least the following: polyesters; polyurethanes; polyalkylene terephthalates; polysulfones; polyimides; polyphenylene ethers; styrenic polymers; polycarbonates, typically based on bisphenol-A reacted with carbonyl chloride; poly(meth)acrylics, typically belonging to two families of esters, acrylates and methacrylates; polyarylether ketones containing ether and ketone groups combined with phenyl rings in different sequences and polyether ketones; polyacrylonitrile resins wherein the principal monomer is acrylonitrile; polyam ides, including various types of nylon-6, nylon-6/6, nylon-6/9, nylon-6/10, nylon-6/12, nylon-11, nylon-12; polyamide-imides formed by the condensation of trimellitic anhydride and various aromatic diamines; polyacetals, typically highly crystalline linear thermoplastic polymers of oxymethylene units; polyacrylates of aromatic polyesters derived from aromatic dicarboxylic acids and diphenols; polybutene resins based on poly(1-butene); polyalkylene terephthalates typically formed in a transesterification reaction between a diol and dimethyl terephthalate; polyetherimides, based on repeating aromatic imide and ether units; polyethylene homopolymers and copolymers, including all molecular weight and density ranges and degrees of crosslinking; polypropylene homopolymers and copolymers; ethylene acid copolymers from the copolymerization of ethylene with acrylic or methacrylic acid or their corresponding acrylate resins; ethylene-vinyl acetate copolymers from the copolymerization of ethylene and vinyl acetate; ethylene-vinyl alcohol copolymers; polyimides derived from the aromatic diamines and aromatic dianhydrides; polyphenylene oxides including polystyrene miscible blends; polyphenylene sulfides; acrylonitrile butadiene styrene terpolymers; polystyrenes; styrene-acrylonitrile copolymers; styrene-butadiene copolymers thermoplastic block copolymers; styrene maleic anhydride copolymers; polyarylsulfones; polyethersulfones; polysulfones; thermoplastic elastomers covering a hardness range of from approximately 30 Shore A to 75 Shore D, including styrenic block copolymers, polyolefin blends (TPOS), elastomeric alloys, thermoplastic polyurethanes (TPUS), thermoplastic copolyesters, and thermoplastic polyamides; polyvinyl chlorides and chlorinated polyvinyl chlorides; polyvinylidene chlorides; allyl thermosets of allyl esters based on monobasic and dibasic acids; bismaleimides based generally on the condensation reaction of a diamine with maleic anhydride; epoxy resins containing the epoxy or oxirane group, including those epoxy resins based on bisphenol A and epichlorohydrin as well as those based on the epoxidation of multifunctional structures derived from phenols and formaldehyde or aromatic amines and aminophenols; phenolic resins; unsaturated thermoset polyesters including those of the condensation product of an unsaturated dibasic acid (typically maleic anhydride) and a glycol, wherein the degree of unsaturation is varied by including a saturated dibasic acid; thermoset polyimides; polyurethanes containing a plurality of carbamate linkages; and urea and melamine formaldehyde resins (typically formed by the controlled reaction of formaldehyde with various compounds that contain the amino group).

Various rubbers are also applicable in this invention, e.g., nitrile butadiene rubber (NBR) is a family of unsaturated copolymers of 2-propenenitrile and various butadiene monomers (1,2-butadiene and 1,3-butadiene). Carboxylated NBR (XNBR) may be applicable in this invention as may other rubbers such as polychloroprene, epichlorohydrin copolymers, styrene-butadiene-rubbers (SBR), polybutadiene elastomers, nitrile rubbers, ethylene-propylene-elastomers, neoprene, polyurethane, polyisoprene, butadiene-acrylonitrile-rubbers, and styrene-isoprene elastomers; halide containing polymers; and polyolefin homopolymers and copolymers.

Additionally included would be mixtures of different polymers, such as polyphenylene ether/styrenic resin blends, polyvinylchloride/ABS or other impact modified polymers, such as methacrylonitrile containing ABS, and polyester/ABS or polyester plus some other impact modifier may also be used. Such polymers are available commercially or may be made by means well known in the art.

Polymers of monoolefins and diolefins, for example would include polypropylene, polyisobutylene, polybutene-1, polymethylpentene-1, polyisoprene or polybutadiene, as well as polymers of cycloolefins, for instance of cyclopentene or norbornene, polyethylene (which optionally can be crosslinked), for example high density polyethylene (HDPE), low density polyethylene (LDPE) and linear low density polyethylene (LLDPE) may be used. Mixtures of these polymers, for example mixtures of polypropylene with polyisobutylene, polypropylene with polyethylene (for example PP/HDPE), may also be used. Also useful are copolymers of monoolefins and diolefins with each other or with other vinyl monomers, such as, for example, ethylene/propylene, LLDPE and its mixtures with LDPE, propylene/butene-1, ethylene/hexene, ethylene/ethylpentene, ethylene/heptene, ethylene/octene, propylene/butadiene, isobutylene/isoprene, ethylene/alkyl acrylates, ethylene/alkyl methacrylates, ethylene/vinyl acetate (EVA) or ethylene/acrylic acid copolymers (EAA) and their salts (ionomers) and terpolymers of ethylene with propylene and a diene, such as hexadiene, dicyclopentadiene or ethylidene-norbornene; as well as mixtures of such copolymers and their mixtures with polymers mentioned above, for example polypropylene/ethylene-propylene copolymers, LDPE/EVA, LDPE/EAA, LLDPE/EVA and LLDPE/EAA.

Thermoplastic polymers may also include styrenic polymers, such as polystyrene, poly-(p-methylstyrene), poly-(α-methylstyrene), copolymers of styrene or α-methylstyrene with dienes or acrylic derivatives, such as, for example, styrene/butadiene, styrene/acrylonitrile, styrene/alkyl methacrylate, styrene/maleic anhydride, styrene/budadiene/ethyl acrylate, styrene/acrylonitrile/methacrylate; mixtures of high impact strength from styrene copolymers and another polymer, such as, for example, from a polyacrylate, a diene polymer or an ethylene/propylene/diene terpolymer; and block copolymers of styrene, such as, for example, styrene/butadiene/styrene, styrene/isoprene/styrene, styrene/ethylene/butylene/styrene or styrene/ethylene/propylene/styrene. Styrenic polymers may additionally or alternatively include graft copolymers of styrene or α-methylstyrene such as, for example, styrene on polybutadiene, styrene on polybutadiene-styrene or polybutadiene-acrylonitrile; styrene and acrylonitrile (or methacrylonitrile) on polybutadiene; styrene and maleic anhydride or maleimide on polybutadiene; styrene, acrylonitrile and maleic anhydride or maleimide on polybutadiene; styrene, acrylonitrile and methyl methacrylate on polybutadiene, styrene and alkyl acrylates or methacrylates on polybutadiene, styrene and acrylonitrile on ethylene/propylene/diene terpolymers, styrene and acrylonitrile on polyacrylates or polymethacrylates, styrene and acrylonitrile on acrylate/butadiene copolymers, as well as mixtures of with the styrenic copolymers indicated above.

Nitrile polymers are also useful in the polymer composition of the invention. These include homopolymers and copolymers of acrylonitrile and its analogs such as methacrylonitrile, such as polyacrylonitrile, acrylonitrile/butadiene polymers, acrylonitrile/alkyl acrylate polymers, acrylonitrile/alkyl methacrylate/butadiene polymers, acrylonitrile/butadiene/styrene (ABS), and ABS which includes methacrylonitrile.

Polymers based on acrylic acids, such as acrylic acid, methacrylic acid, methyl methacrylate acid and ethacrylic acid and esters thereof may also be used. Such polymers include polymethylmethacrylate, and ABS-type graft copolymers wherein all or part of the acrylonitrile-type monomer has been replaced by an acrylic acid ester or an acrylic acid amide. Polymers including other acrylic-type monomers, such as acrolein, methacrolein, acrylamide and methacrylamide may also be used.

Halogen-containing polymers may also be useful. These include resins such as polychloroprene, epichlorohydrin homopolymers and copolymers, polyvinyl chloride, polyvinyl bromide, polyvinyl fluoride, polyvinylidene chloride, chlorinated polyethylene, chlorinated polypropylene, fluorinated polyvinylidene, brominated polyethylene, chlorinated rubber, vinyl chloride-vinylacetate copolymer, vinyl chloride-ethylene copolymer, vinyl chloride-propylene copolymer, vinyl chloride-styrene copolymer, vinyl chloride-isobutylene copolymer, vinyl chloride-vinylidene chloride copolymer, vinyl chloride-styrene-maleic anhydride tercopolymer, vinyl chloride-styrene-acrylonitrile copolymer, vinyl chloride-isoprene copolymer, vinyl chloride-chlorinated propylene copolymer, vinyl chloride-vinylidene chloride-vinyl acetate tercopolymer, vinyl chloride-acrylic acid ester copolymers, vinyl chloride-maleic acid ester copolymers, vinyl chloride-methacrylic acid ester copolymers, vinyl chloride-acrylonitrile copolymer and internally plasticized polyvinyl chloride.

Other thermoplastic polymers include homopolymers and copolymers of cyclic ethers, such as polyalkylene glycols, polyethylene oxide, polypropylene oxide or copolymers thereof with bis-glycidyl ethers; polyacetals, such as polyoxymethylene and those polyoxymethylene with contain ethylene oxide as a comonomer; polyacetals modified with thermoplastic polyurethanes, acrylates or methacrylonitrile containing ABS; polyphenylene oxides and sulfides, and mixtures of polyphenylene oxides with polystyrene or polyam ides; polycarbonates and polyester-carbonates; polysulfones, polyethersulfones and polyetherketones; and polyesters which are derived from dicarboxylic acid and diols and/or from hydroxycarboxylic acids or the corresponding lactones, such as polyethylene terephthalate, polybutylene terephthalate, poly-1,4-dimethyliol-cyclohexane terephthalate, poly-[2,2,4-(4-hydroxyphenyl)-propane]terephthalate and polyhydroxybenzoates as well as block copolyetheresters derived from polyethers having hydroxyl end groups.

Polyamides and copolyamides which are derived from diamines and dicarboxylic acids and/or from aminocarboxylic acids or the corresponding lactams, such as polyamide-4, polyamide-6, polyamide-6/6, polyamide-6/10, polyamide-6/9, polyamide-6/12, polyamide-4/6, polyamide-11, polyamide-12, aromatic polyam ides obtained by condensation of m-xylene, diamine and adipic acid; polyam ides prepared from hexamethylene diamine and isophthalic and/or terephthalic acid and optionally an elastomer as modifier, for example, poly-2,4,4-trimethylhexamethylene terephthalamide or poly-m-phenylene isophthalamide may be useful. Further copolymers of the aforementioned polyamides with polyolefins, olefin copolymers, ionomers or chemically bonded or grafted elastomers; or with polyethers, such as for instance, with polyethylene glycol, polypropylene glycol or polytetramethylene glycols, and polyamides or copolyamides modified with EPDM or ABS may be used.

While organic polymers have been described above, inorganic polymeric sealants are also applicable in this invention, e.g., silicone is an inorganic polymer, a polysiloxane or polydimethylsiloxane. Silicone rubbers are typically cured or vulcanized.

The combination of the above polymers must satisfy at least two simultaneous conditions. First, the plastic compartment must not soften and begin melt flow to the point where it loses structural integrity and second, the injection molded sealant polymer must be capable of forming an at least partially bonded interface with the plastic compartments, preferably through either a chemical and/or physical bond between the underlying plastic and the injection molded plastic. One of the keys is the recognition that the plastic compartments must be capable of maintaining structural integrity during the injection molding conditions during which the injection molded polymer is in melt flow.

In an aspect of the invention, the composition of the injection molded polymer will be such that it will be capable of at least some melt fusion with the composition of the plastic components, thereby maximizing the bond at the interface between the plastic components and injection molded plastic. There are several means by which this may be effected. One of the simplest procedures is to insure that at least a component of the composition of the plastic component and that of the injection molded polymer is the same. Alternatively, it would be possible to insure that at least a portion of the polymer composition of the plastic conduit and that of the injection molded polymer is sufficiently similar or compatible so as to permit the melt fusion or blending or alloying to occur at least in the interfacial region between the exterior of the plastic component and the injection molded polymer. Another manner in which to state this would be to indicate that at least a portion of the polymer compositions of the plastic composition and the injection molded polymer are miscible.

In yet another embodiment, composites of rubber/thermoplastic blends are useful in adhering to thermoplastic materials used in the plastic composition. These blends are typically in the form of a thermoplastic matrix containing rubber nodules functionalized and vulcanized during the mixing with the thermoplastic. The composite article is then obtained by injection molding the vulcanized rubber/thermoplastic blend onto the thermoplastic conduit. In this manner, the cohesion at the interface between these two materials is generally higher than the tensile strength of each of the two materials. The quantity of vulcanizable elastomer may be from 20 to 90% by weight of the vulcanizable elastomer block copolymer combination. This block copolymer compromises a polyether or amorphous polyester block as the flexible elastomeric block of the thermoplastic elastomer while polyamide, polyester or polyurethane semicrystalline blocks for the rigid elastomeric block of the thermoplastic elastomer.

It is also known to add various colorants to any or all of the above classes and types of polymers, and at least one aspect of this invention involves adding a unique colorant identifier to either the compartment and/or sealant composition for use by the consumer in choosing a product.

While a powered air purifying respirator has been described in which the HEPA filter is affixed to a user's belt, there is no need to limit the invention to such. Welding helmets in which the HEPA filter and/or fans are positioned either upon or within a welding helmet are also within the ambit of this invention. The shape of the cartridge filter may be curvilinear or essentially linear depending upon the dimensions of the filter.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for making a filter cartridge comprising the steps of:
inserting a filter into a polymeric filter cartridge, said cartridge having an apertured bottom and a pair of opposed raised sides;
inserting a cartridge into said bottom apertured filter cartridge;
affixing a polymeric apertured retaining top onto a top of said filter cartridge to form a filter assembly;
positioning said filter assembly into a split mold having a cavity dimensioned to accommodate said filter assembly, one side of said split mold having a cavity about a periphery of said filter assembly;
injection molding a sealing polymer about said periphery of said filter assembly, said sealing polymer and said polymeric filter cartridge or said polymeric retaining top forming either a chemical or physical bond therebetween; and
opening said split mold and removing said filter assembly having a sealing polymer about said periphery of said filter assembly.

2. The process of claim 1 wherein
said sealing polymer and said polymeric filter cartridge or said polymeric retaining top are at least partially miscible.

3. The process of claim 1 wherein
at least a portion of said sealing polymer composition and at least a portion of said polymeric filter cartridge or at least a portion of said polymeric retaining top are compatible.

4. The process of claim 3 wherein
said sealing polymer composition and said polymeric filter cartridge or said polymeric retaining top are at least partially miscible.

5. The process of claim 1 wherein
said retaining top fits into a lip of a top surface of said pair of opposed raised sides of said polymeric filter cartridge.

6. The process of claim 1 wherein
said sealing polymer is colored.

7. The process of claim 1 wherein
said polymeric filter cartridge and said polymeric retaining top are curvilinear along a longitudinal axis.

8. The process of claim 1 wherein
said sealing polymer has a range of from approximately 30 Shore A to 75 Shore D.

9. The process of claim 1 wherein
the composition of said polymeric filter cartridge and said polymeric retaining top are of a plastic which is harder than said sealing polymer using a Shore scale.

10. The process of claim 1 wherein
said filter is a high efficiency particulate air or HEPA filter.
